(19) United States
(12) Patent Application Publication
(10) Pub. No.: US 2007/0129063 A1
(43) Pub. Date: Jun. 7, 2007

(54) Digital information retrieval for wireless phones

(76) Inventors: Renato J. Recio, Austin, TX (US); Joanne M. Santiago, Cedar Park, TX (US)

Correspondence Address: IBM CORPORATION (RVW), C/O ROBERT V. WILDER, ATTORNEY AT LAW, 4235 KINGSBURG DRIVE, ROUND ROCK, TX, 78681, US

(21) Appl. No.: 11/291,545

(22) Filed: Dec. 1, 2005

(51) Int. Cl. H04Q 7/38

(52) U.S. Cl. 455/414.1

(57) ABSTRACT

A method and implementing system are provided for enabling a wireless phone to access a remote server service containing digital address and phone number database information in digital form. In an exemplary embodiment, a user is provided with the ability to retrieve and store entries from a cell or other wireless service provider database in a user's phone memory based upon GPS information transmitted from the user's wireless phone. Digital directory information is transmitted from a remote server database to a requesting caller's wireless phone and stored in the caller's phone directory.

### FIELD OF THE INVENTION

The present invention relates generally to information processing systems and more particularly to a methodology and implementation for accessing and updating wireless phone directory records.

### RELATED APPLICATIONS

Subject matter disclosed but not claimed herein is disclosed and claimed in co-pending application 05-0682.

### BACKGROUND OF THE INVENTION

Global Positioning System or GPS is a technology for assigning a geographic location to a device or a location on the earth. A GPS receiver on the surface of the earth communicates with a set of GPS satellites orbiting the earth to derive an accurate position. GPS receivers have become very inexpensive and are being designed into more and more personal computing devices including personal digital assistant (PDA) devices as well as laptop computers, automobile navigation systems and other wireless devices.

Without the integration of GPS navigation technologies and wireless or cell phones, consumers have needed to carry around two products to contact a person or a business at a given address. Initially the caller has to look up or find and address or a phone number using a “411” type service, and then the caller needs to write down the address and manually enter it into his GPS device. Today this requires two devices, a cell phone and a GPS enabled device, and manual intervention which is difficult, for example, when a person is driving. Consumers need a mechanism that allows them to store entries looked up through the cell providers 411 system, into the consumer's GPS Cell Phone Memory.

Thus, there is a need for an improved methodology and system for providing access to, and local storage for, location-related information received from a location-based information system using a wireless device.

### SUMMARY OF THE INVENTION

A method and implementing system are provided for enabling a wireless phone to access a remote server service containing digital address and phone number database information in digital form. In an exemplary embodiment, a user is provided with the ability to retrieve and store entries from a cell or other wireless service provider database in a user's phone memory based upon GPS information transmitted from the user's wireless phone. Digital directory information is transmitted from a remote server database to a requesting caller's wireless phone and stored in the caller's phone directory.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration showing an overall communication system in which the present invention may be implemented;

FIGS. 2 is a block diagram illustrating several of the components within a wireless communication device used in one exemplary implementation of the present invention;

FIG. 3 is an illustration of a screen display which may be used in connection with the present invention;

FIG. 4 is an illustration of another screen display which may be used in connection with the present invention;

FIG. 5 is an illustration of another screen display which may be used in connection with the present invention;

FIG. 6 is an illustration of a digital information database which may be accessed in accordance with the present invention;

FIG. 7 is a flowchart illustrating an exemplary operational sequence of the directory information retrieval process disclosed herein using a digital information request mechanism;

FIG. 8 is an extension of the FIG. 7 flow chart showing an operational processing sequence in an exemplary implementation of the present invention;

FIG. 9 is a flowchart illustrating an exemplary operational sequence of the directory information retrieval process disclosed herein using an audio information request format;

FIG. 10 is an extension of the FIG. 9 flow chart showing an operational processing sequence in an exemplary implementation of the present invention; and

FIG. 11 is an extension to FIG. 7 and FIG. 9 showing an operational processing sequence in an exemplary implementation of the present invention.

### DETAILED DESCRIPTION

It is noted that circuits and devices which are shown in block form in the drawings are generally known to those skilled in the art, and are not specified to any greater extent than that considered necessary as illustrated, for the understanding and appreciation of the underlying concepts of the present invention and in order not to obfuscate or distract from the teachings of the present invention. Although the present invention is herein disclosed using a cellular wireless communication device in the example, it is understood that the invention applies equally as well to wireless communication devices of all kinds including, but not limited to Personal Digital Assistant (PDA) devices, wireless computers and wireless phones using other than cellular technologies.

This disclosure describes a digital mechanism that allows users to store in the directory of a GPS Navigation capable Cell Phone, entries which have been retrieved or looked-up through a cell service provider's “411” system or other address and phone number data retrieval service. After the data is retrieved, a digital information transmission exchange is used by the GPS cell phone provider to send a message to the user's GPS cell phone that contains the GPS data associated with the requested location lookup. The user can then use the entry to route to the location it references, store the entry in the cell phone's library or directory of entries, or both.

A method and implementing system are provided for enabling a wireless phone to access a remote server service containing digital address and phone number database information in digital form. In an exemplary embodiment, a user is provided with the ability to retrieve and store entries from a cell or other wireless device service provider's database into a user's phone memory. The retrieved information includes GPS navigation system information, as well as information relevant to the location. For example, if the location is a restaurant the location relevant information includes items such as the restaurant: rating, price range, and menu type. Digital directory information is transmitted from a remote server database to a requesting caller's wireless phone and stored in the caller's phone directory. The digital transmission retrieval request may be initiated verbally by the user from an audio information retrieval service, such as 411. In this case, the response is still transmitted in digital form from the information directory service to the user's cell phone, after the information retrieval service locates the information requested by the user. Once the information is received by the cell phone, the user may also store the entry, tag the entry with an audio word (e.g. the name of the location, such as Phil's Diner), and then recall it later for use, where the use can include phone number lookup or GPS location lookup of the entry.

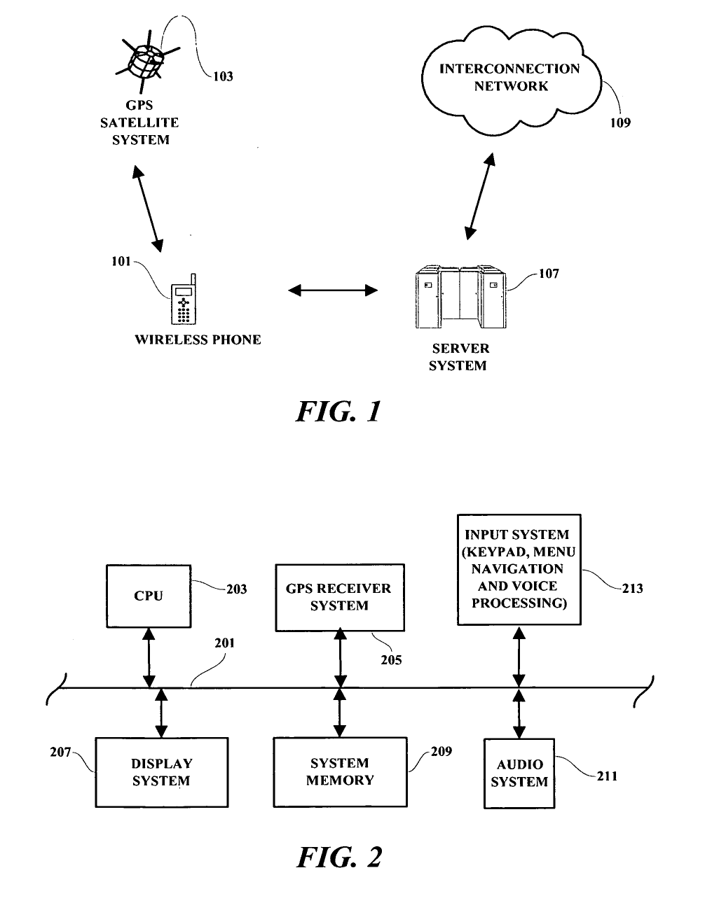

As shown in FIG. 1, an exemplary communication network includes a wireless cellular phone 101 which is operable to receive GPS location signals from a GPS satellite system 103 which typically includes a group of three satellites. The wireless phone 101 is operable to transmit to and receive signals from a cellular service provider's base server system 107. The server, in turn, is operable to be connected through an interconnection network 109 such as the Internet, to other servers for information access and retrieval as necessary. In the present example, the server system 107 contains an address and phone number database, similar to a telephone directory, which may be accessed with one field of information in order to obtain a full record of information. The server system 107 also may include a GPS object associated to each address that may be used in GPS navigation enabled devices, where the GPS object may contain but is not limited to, the GPS coordinates of the location. For example, the server 107 may be accessed, as herein disclosed, with a known location name, such as Phil's Diner, or the known address. As shown in FIG. 2, the wireless phone 101 includes, among other components, a main bus 201 to which is connected a CPU unit 203, a GPS receiver system 205, a display system 207, a system memory 209 and an audio system 211. Also connected to the main bus 201 is an input unit 213 which includes a keypad system for enabling user keypad input, a wireless telephone menu navigation system for enabling navigation through selection menus presented on the display screen of the phone, and voice processing circuitry for translating voiced input into digital signals.

Additionally, in a digital mode, the cellular phone 101 is used to call a “411” number for example, to request the address and or telephone number for a person at a given address. This information is given verbally to an operator and in response, either the operator or a voicing machine, provides the telephone number or address requested in verbal format to the caller. The caller may also request to have the phone number and corresponding GPS data, which may include the address and the GPS coordinates, sent to the caller's cell phone. This process saves the caller from incurring an extra expense to have the number dialed by the operator or manually entering the address into the cell phone. It also saves the information in the caller's directory without requiring the caller to write down the information and then enter the information separately into the caller's library or directory.

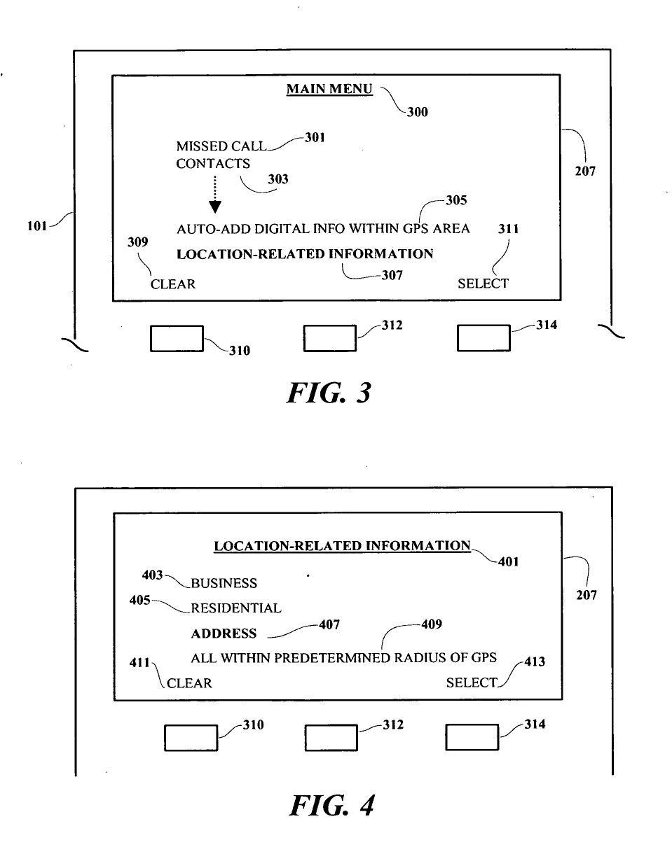

FIG. 3 shows the display area 207 of a cellular phone 101. A Main Menu 300 is displayed which includes several categorical headings including “Missed Call” 301 and “Contacts” 303. The Main Menu also includes selection icons for “Auto-add Digital Information” 305 and “Location-Related Information” 307. The menu also shows a CLEAR function 309 for returning to a home page, and a SELECT icon 311 which may be selected to actuate a highlighted sub-menu or other operation. Several selection buttons 310, 312 and 314 are also shown below the display area 207. The selection button 314 is operable when depressed to select a menu item which has been highlighted by a user. For example, as shown, the menu item LOCATION-RELATED INFORMATION has been highlighted by the user and a depression of selection button 314 will cause the display illustrated in FIG. 4 to be displayed.

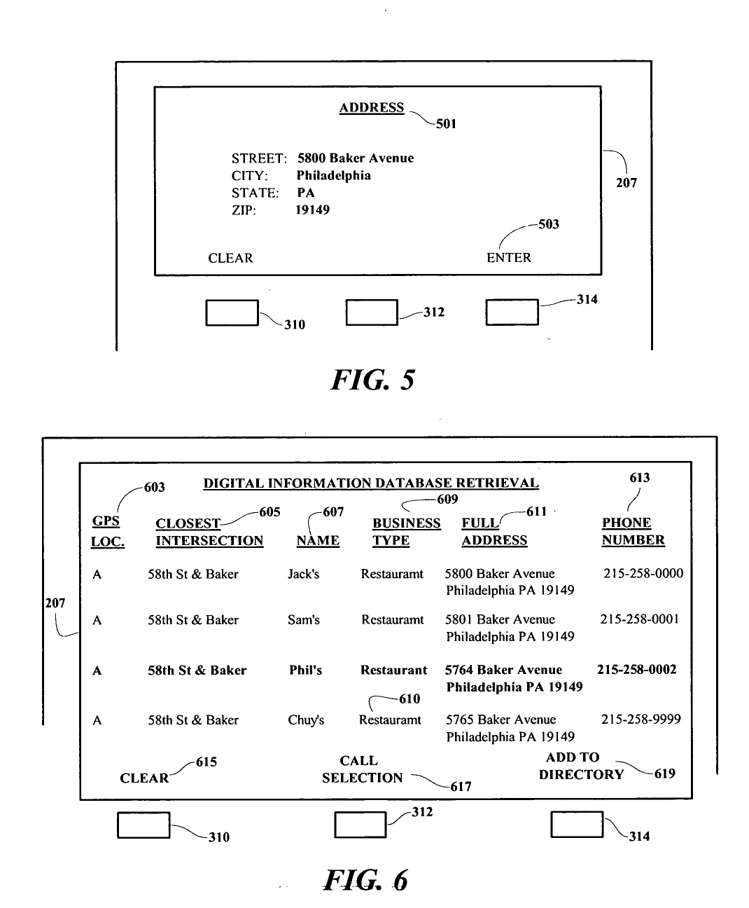

As shown in FIG. 4, a “LOCATION-RELATED INFORMATION” menu 401 enables a user to choose a BUSINESS 403 or RESIDENTIAL 405 selection, or to select an ADDRESS 407 for input. As shown, the user has highlighted the ADDRESS icon 407 and when the user depresses the select button 314, an ADDRESS display 501 will be displayed as indicated in FIG. 5. The user may then chose to have the address displayed via the cell phone's GPS system in order to aid the user in navigation to the requested location.

FIG. 5 enables a user to input one or more fields of an address for which the user wishes to obtain the phone number. The input may be made using the cell phone keypad. The user may input any part of the address and then depress the selection button 314 at which time, the user's request will be sent to the “411” server (107, FIG. 1) for example, and the address and phone number database will be searched using the portion of the address input by the user. All address records in the database that match the user input will be returned to the user and displayed on the user's cell phone and the user is then able to select which address and phone number, if any, the user wishes to navigate to, save, view the full GPS navigation information to, and/or dial.

If the user chooses to find out all of the phone numbers and digital information for a specific type of business (e.g. restaurants) within a predetermined radius of the user's cell phone GPS, the user will choose the “ALL WITHIN” selection 409 (FIG. 4), and the digital information server 107 will search the address and phone number digital

information database and assemble the information as shown in FIG. 6.

FIG. 6 shows an exemplary display of the address and phone number digital information assembled by the server 107 and transmitted to and displayed upon the user's cell phone. It is noted that the full address fields 611 may be represented only by icons instead of the detailed full address in order to present larger print on the cell phone display area. In that case, if the user wishes to see the address, the user will be able to select a displayed icon and the next screen (not shown) will present only the address information of the address selected by the user. It is noted that when the request for digital information is sent from the user's cell phone 101 to the server 107, the user's GPS location is also determined by the user's GPS receiver system 205 and sent along with the digital request. The cell phone provider's digital information database is searched to determine all businesses of the type the user selected within the predetermined radius the user selected, for example 50 meters, of the user's GPS location. The user may also perform “any” business type of request, which returns all the various businesses within the radius selected by the user.

FIG. 6 shows an example of a display resulting from a search of the digital information database where the GPS location of the cell phone user making the request is indicated as location “A” in the GPS location column 603. The digital information database also includes fields for the closest intersection 605 to the GPS location of the user as well as each business name 607 and type of business 609 within a predetermined distance from the given GPS location of the requesting cell phone. If any of the phone numbers is that of a residence instead of a business, the business field will so indicate by inserting the word “Residence” 610. In cases where the phone number of a residence is not listed or publicly available, the name and phone number entries may not be displayed. If the full address is available, it will be displayed 611 subject to space limitations. Also, the phone number or numbers for each business or residence within the predetermined distance of the caller's GPS location will also be displayed 613 on the user's cell phone display 207. Other entries may also be included in the database for the purpose of enabling a user to search for additional information. Moreover, since the server 107 is connectable through an interconnection network 109 to other servers and databases, additional information may be requested and retrieved. In the given example, the user has called for digital address and phone number information from an intersection where two pharmacies, a restaurant and a residence are located. The search has resulted in the FIG. 6 display from which the user is enabled to select what further action is to be taken with regard to the returned records. In the example, it is assumed that the user is interested only in calling “Phil's” restaurant. The user may then make the phone call by depressing button 312 corresponding to the “CALL SELECTION” menu item 617. The user may also store or add the phone number for “Phil's” restaurant to the user's cell phone directory, by depressing button 314 which corresponds to a command to “ADD TO DIRECTORY” 619. The user may then end the process by depressing button 310 corresponding to menu item CLEAR 615.

The caller may also automatically add all phones within a predetermined radius of the caller's GPS location (i.e. as shown in FIG. 6) to the caller's directory or library by highlighting the Auto-Add selection 305 from the main menu 300 and sending the request to the “411”server 107. In that case, the entries as shown in FIG. 6 will automatically be added to the user's directory without further action by the user, and the user may, at a more convenient time, delete any unwanted entries.

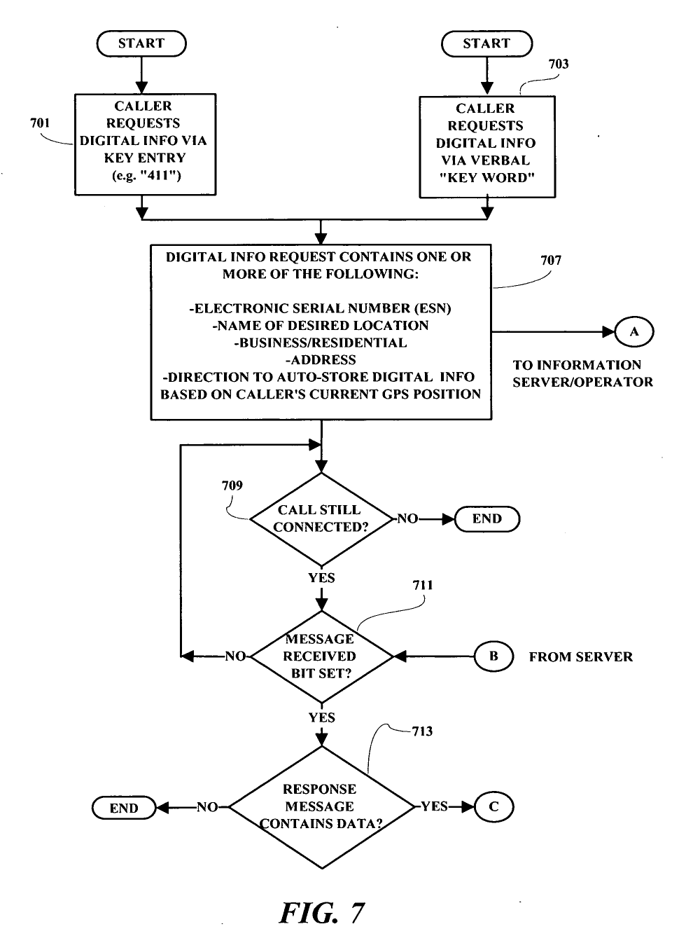

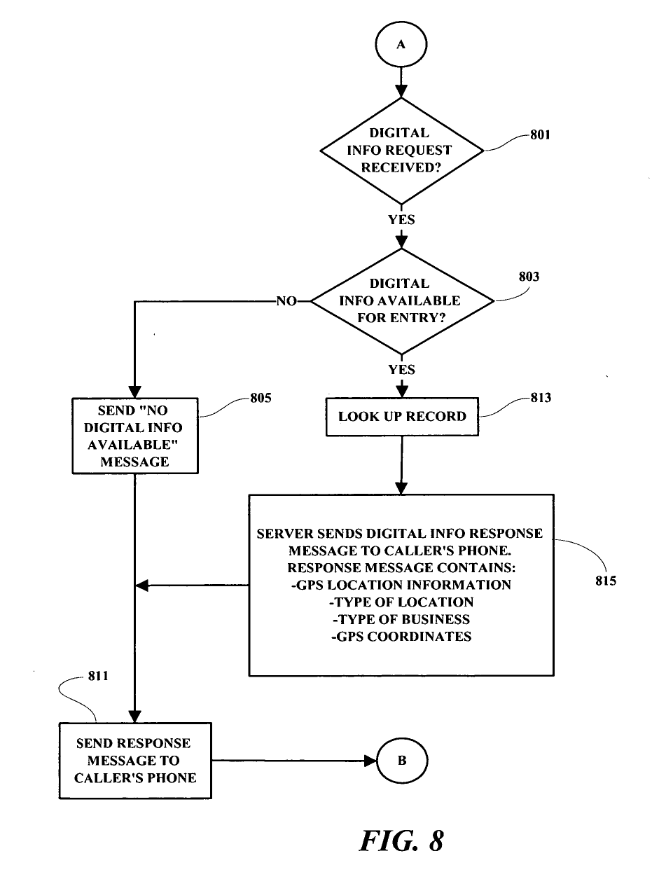

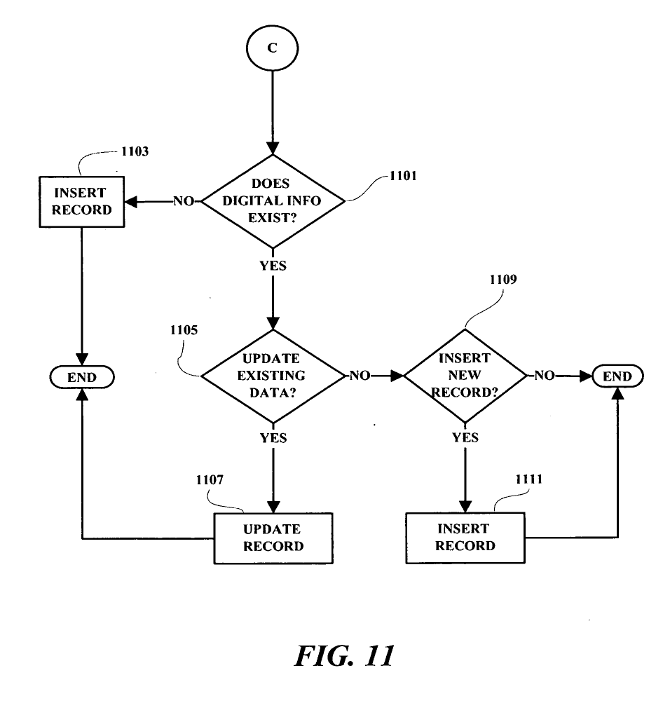

FIG. 7 is a flowchart illustrating an exemplary operational sequence of the directory information retrieval process disclosed herein using a digital information request mechanism. As shown, a caller may request directory information by entering a designated keypad entry 701 such as “411” plus the type of information requested (e.g. restaurants within 1 mile of current GPS location) or by speaking a designated “key word” 703 recognizable by the voice processing system (e.g. by saying: “restaurants within 1 mile of current GPS location”). The digital information request 707, in the example, contains one or more, inter alia, of the following pieces of information: (1) an electronic serial number of the cell phone; (2) name of the desired location; (3) whether the requested phone number is business or residential; (4) any portion of the address for the requested information; (5) a direction to automatically store the retrieved digital information; and/or the caller's current GPS position which is automatically sent with the request. The input information from the requesting caller is sent to the information server operator “A” (FIG. 8) for further processing. The requesting caller remains connected 709 until a message received bit is set 711 at which time a check is made to determine if the response message from the server contains data 713. If the response message contains data 713, the process continues to flowchart point “C” which is shown in FIG. 11. At any time if the requestor's call is disconnected 709 or if the response message from the server contains no data 713, the processing is ended.

As shown in FIG. 8, when a request for digital directory information is received 801 by the server 107, a check is made to determine if digital information is available for the request entry 803. If digital information is not available 803, an appropriate “No Digital Info Available” message is generated 805. Next a response message is sent to the caller's phone 811 indicating there is no data and the processing ends.

If digital information is available for the received entry 803, the appropriate directory record is fetched or looked-up 813 and the server sends the digital information response to the caller's phone 815. The response message contains, inter alia, the following items of information: (1) GPS location information, i.e. information related to the requested location; (2) type of location, i.e. business or residence; (3) type of business if the location is a business; and (4) GPS coordinates of the requested location. Finally, the requested directory digital information is sent to the caller's phone 811 and the processing continues at point “B” in FIG. 7.

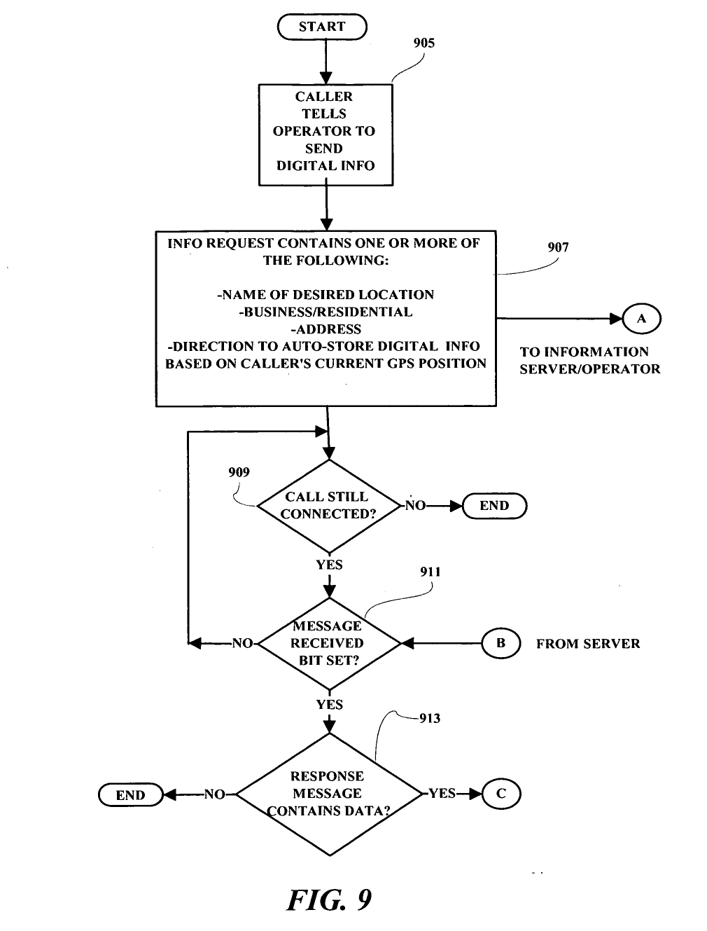

FIG. 9 is a flowchart illustrating an exemplary operational sequence of the directory information retrieval process disclosed herein using an audio information request format. As shown, a caller may request directory information by simply telling a “411” information service operator to send the designated digital information 905 such as a directory record associated with a given address. The information request 907, in the example, contains one or more, inter alia, of the following pieces of information: (1) name of the desired location; (2) whether the requested phone number is business or residential; (3) a direction to automatically store the retrieved digital information; and/or (4) the caller's current GPS position which is automatically sent with the request. The input information from the requesting caller is sent to the information server operator “A” (FIG. 8) for further processing. The requesting caller remains connected 909 until a message received bit is set 911 at which time a check is made to determine if the response message from the server contains data 913. If the response message contains data 913, the process continues to flowchart point “C” which is shown in FIG. 11. At any time if the requestor's call is disconnected 909 or if the response message from the server contains no data 913, the processing is ended.

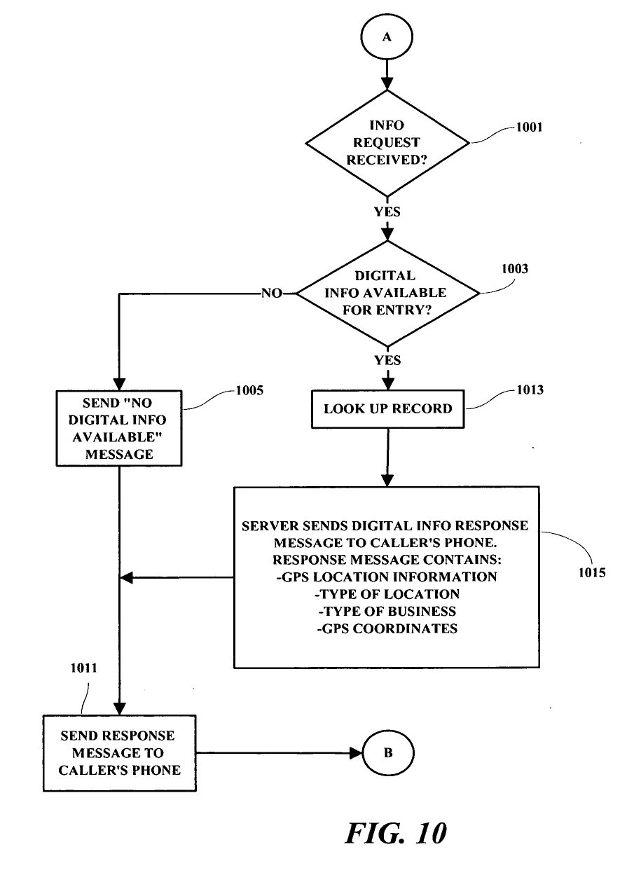

As shown in FIG. 10, when a request for digital directory information is received 1001 by the “411” information service operator 107, a check is made to determine if digital information is available for the request entry 1003. If digital information is not available 1003, the operator lets the caller know or sends a digital “No Digital Info Available” message 1005. Next a response message is sent to the caller's phone 1011 indicating there is no data and the processing continues to point “B” in FIG. 9.

If digital information is available for the received entry 1003, the appropriate directory record is fetched or looked-up 1013 and the server sends the digital information response to the caller's phone 1015. The response message contains, inter alia, the following items of information: (1) GPS location information, i.e. information related to the requested location; (2) type of location, i.e. business or residence; (3) type of business if the location is a business; and (4) GPS coordinates of the requested location. Finally, the requested directory digital information is sent to the caller's phone 1011 and the processing continues at point “B” in FIG. 9.

If the response message from the server contains data 713 (FIG. 7) or 913 (FIG. 9), then the process continues to point “C” in FIG. 11. As shown in FIG. 11, if the digital information sent from the server already exists 1101 in the directory of the caller's cell phone, then a determination is made whether or not to update the existing data 1105. If the existing record is to be updated 1105 then the record is updated 1107 and the process is ended. If the information from the server does not already exist in the caller's cell phone 1101, then the record sent from the server is inserted into the caller's cell phone directory 1103 and the process is ended. If the record sent from the server already exists in the caller's cell phone directory, and a determination is made not to update existing data 1105 (usually by a caller default selection) and not to insert a new record 1109, then the process ends. If, however, the decision is made to insert the new record 1109 sent from the server, then the new record is inserted into the caller's cell directory and the process ends.

As previously noted, once the record is inserted or stored in the caller's cell phone direction, the caller may then quickly highlight the new telephone number for speed dialing or select the address for GPS routing to the location. Thus, by using the caller's requested location to search a server-based telephone directory and returning directory information in digital format for storing at the caller's cell phone memory, a user is enabled to quickly find and either call or navigate to the location via the caller's GPS cell phone.

The method and apparatus of the present invention has been described in connection with a preferred embodiment as disclosed herein. The disclosed methodology may be implemented in a wide range of sequences to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored on a storage medium from which it may be loaded into memory and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for obtaining digital phone directory information from a wireless phone, said method comprising:
sending a request by a caller for said digital phone directory information from said wireless phone to a phone directory information service provider, said request including location information related to a location for which said caller is requesting digital phone directory information;
searching a database at said phone directory information service provider to determine one or more records which include at least a portion of said location information provided by said caller; and
sending said one or more records from said phone directory information service provider to said wireless phone in response to said request.

2. The method as set forth in claim 1 wherein said location information includes one or more address elements of a physical address which are input to said wireless phone by said caller.

3. The method as set forth in claim 2 wherein said address elements are input verbally.

4. The method as set forth in claim 2 wherein said address elements are input using a keypad device.

5. The method as set forth in claim 1 wherein said one or more records are sent from said phone directory information service provider in digital format.

6. The method as set forth in claim 1 wherein said one or more of said records include GPS (Global Positioning System) information associated with each of a plurality of address and telephone number entries.

7. The method as set forth in claim 1 wherein said wireless phone includes a GPS receiver unit for determining a location of said wireless phone.

8. The method as set forth in claim 7 wherein GPS information is determined and included within said request for said digital phone directory information sent from said phone directory information service provider to said wireless phone in response to said request.

9. The method as set forth in claim 8 wherein said one or more records sent from said phone directory information service provider to said wireless phone in response to said request include an indication of whether a phone number in said one or more records is associated with a business or a residence.

10. The method as set forth in claim 8 wherein said one or more records sent from said phone directory information service provider to said wireless phone in response to said request include a name associated with each of said records.

11. The method as set forth in claim 8 wherein said one or more records sent from said phone directory information service provider to said wireless phone in response to said request include a description of a business associated with each of said records.

12. The method as set forth in claim 8 wherein said one or more records sent from said phone directory information service provider to said wireless phone in response to said request include the address associated with each of said records.

13. The method as set forth in claim 1 wherein said one or more records sent from said phone directory information service provider to said wireless phone in response to said request are automatically stored in a memory device within said wireless phone in response to said request.

14. The method as set forth in claim 13 and further including enabling said caller to speed dial phone numbers which have been automatically stored in a memory device within said wireless phone in response to said request.

15. The method as set forth in claim 13 and further including enabling said caller to navigate to the address using the GPS information which has been automatically stored in a memory device within said wireless phone in response to said request.

16. A wireless phone comprising:
a main bus;
a processing unit coupled to said main bus;
a memory unit coupled to said main bus;
means for sending a request by a caller for digital phone directory information from said wireless phone to a phone directory information service provider, said request including location information related to a target location for which said caller is requesting digital phone directory information, said phone directory information service provider being enabled for searching a database at said phone directory information service provider to determine one or more records which include at least a portion of said location information provided by said caller, said wireless phone including means for receiving said one or more records from said phone directory information service provider in response to said request, said wireless phone being enabled for storing said one or more records in said memory unit.

17. The wireless phone as set forth in claim 16 and further including a GPS receiver device for determining a location of said wireless phone.

18. The wireless phone as set forth in claim 17 wherein GPS location of said wireless phone is determined and included within said request for said digital phone directory information, said records received from said phone directory information service provider further including route information descriptive of a navigational route from said location of said wireless phone to said target location.

19. A programmed medium within a wireless phone, said programmed medium being selectively accessible to provide program signals operable for enabling said wireless phone to obtain digital phone directory information from a phone directory information service provider, said program signals being further operable for:
sending a request by a caller for said digital phone directory information from said wireless phone to a phone directory information service provider, said request including location information related to a location for which said caller is requesting digital phone directory information;
searching a database at said phone directory information service provider to determine one or more records which include at least a portion of said location information provided by said caller; and
sending said one or more records from said phone directory information service provider to said wireless phone in response to said request.
